(19) United States
(12) Patent Application Publication
(10) Pub. No.: US 2024/0098355 A1
(43) Pub. Date: Mar. 21, 2024

(54) CAMERA SYSTEM TO MONITOR GOODS IN CABINET

(71) Applicant: Leftbrain Limited, Napier (NZ)

(72) Inventor: Craig HARDING, Napier (NZ)

(21) Appl. No.: 18/272,762

(22) PCT Filed: Jan. 17, 2022
(86) PCT No.: PCT/NZ2022/050004

§ 371 Date: Jul. 17, 2023

(30) Foreign Application Priority Data
Jan. 18, 2021 (NZ) 772013

(51) Int. Cl. H04N 23/57; F25D 27/00; G01S 17/08; H02J 50/10; H04N 23/56

(52) U.S. Cl. CPC H04N 23/57; F25D 27/00; G01S 17/08; H02J 50/10; H04N 23/56; A47F 2010/025

(57) ABSTRACT

Provided herein is a camera system for installation in a cabinet, preferably a food display cabinet, and a cabinet incorporating the camera system. The camera system allows monitoring of stock levels in the cabinet with reference to a planogram showing specific locations for different products. The camera system can be retrofitted to an existing cabinet or incorporated into the cabinet during manufacture. The camera system includes a strip containing one of more cameras, which attaches to the inner surface of a closure assembly for said cabinet.

This invention relates to monitoring of cabinets for displaying goods, particularly monitoring of food cabinets, more particularly chiller/refrigerator cabinets (herein referred to as a refrigerator for convenience) and freezer cabinets.

The invention is designed in connection with display of chilled or frozen goods including food goods in food outlets including supermarkets and stores, however, it will be clear to those of skill in the art that the cabinets of the present invention will have the potential for broader application due to the benefits and advantages described herein.

### BACKGROUND

The display and sale of chilled and frozen goods is subject to several food safety requirements. Chilled and frozen goods must be maintained at the correct temperature. Usually, refrigerator or freezer space which provides a controlled temperature in a retail outlet is limited, and restocking must take place on a regular basis. This may involve regular visits from a refrigerated truck, or resupply from a larger freezer at the rear of the retail outlet premises to restock different lines of goods, which may require restocking at different rates.

Refrigerator and freezer cabinets in retail outlets are advantageously equipped with closure assemblies such as doors, panels or covers to increase energy efficiency. It is important that the closure assemblies, doors, panels or covers are easy to use, and provide ease of visibility, for both consumers and staff restocking goods. For these reasons, closure assemblies comprising glass or acrylic are preferable.

It can be difficult to predict when restocking of different lines is required, and if popular goods are left out of stock, this can result in loss of sales.

The correct and consistent locating of different stock items in the cabinet is important to maximise sales. An efficient way of locating stock items is to organize them with reference to a planogram, a diagram which defines the location of each stock item in the cabinet. Knowing the state of planogram compliance for each cabinet is therefore preferable.

It is desirable to address one or more of the above problems. It is also desirable to address one or more of these problems without the need to replace existing cabinets.

In the description of the invention which follows, examples are given of refrigerator and freezer cabinets. However, it will be appreciated that the invention has wider applicability to monitor any type of goods stored in a cabinet.

### SUMMARY OF THE INVENTION

According to a first broad aspect, the invention provides a camera system for a cabinet having a base and sides defining a cavity for receiving stock, and at least one closure assembly above said cavity, the closure assembly having an inward facing surface to face the cavity and an outward facing surface, the camera system including
a strip to be affixed to the inward facing surface of said closure assembly, the strip comprising at least one circuit layer to receive, store and transmit data, and at least one camera associated with the circuit layer; and
means to supply power to the circuit layer.

The invention is most suited to the cabinet having a base and sides defining a cavity, and slidably mounted closure assembly(s) above said cavity. Such cabinets are commonly known as chest cabinets, and some are known as glass door chest freezers, despite the fact that the closure assemblies are slidably mounted rather than being hinged as for a furniture chest.

The camera system is advantageously adapted to ascertain the distance between the camera and the stock in the cabinet, and thereby ascertain the amount of stock in the cabinet.

The camera system may include an induction transmitter (alternatively named a wireless transducer) to supply power to the circuit layer, and the strip may include a receiver in which a current will be induced.

Alternatively, the camera system may include infrared LED(s) and the strip may be associated with one or more photovoltaic cells to supply power to the circuit layer.

Additionally, or alternatively, the camera system may be associated with a rechargeable or replaceable battery. A battery can keep the camera system running while the closure assembly is not near the induction transmitter (or in lieu of an induction transmitter). In some embodiments, a supercapacitor can be provided to act as a battery. While a supercapacitor is a capacitor rather than a battery, the advantage is that there is no chemical reaction required to store power, hence the number of re-charges available rises from a few thousand to a few million.

The strip may comprise two or more cameras.

The cabinet may be, for example, a refrigerator or a freezer.

The strip may be adapted to be fixed to an inward facing surface of the cabinet, for example using adhesive. The strip may comprise an adhesive layer, which may comprise a polycarbonate or polyester film.

Preferably, for aesthetic reasons, the adhesive surface of the strip which will be visible to the consumer through the glazing unit of the closure assembly is decorated for example with a pattern; or is colour matched to the joinery of the closure assembly.

The strip may include a transparent cover, such as a dome or window to protect the or each camera.

Optionally, the strip may include one or more illumination LEDs to illuminate the interior of the cabinet.

Optionally, the strip includes a spacer layer between the circuit layer and the cavity of the cabinet. The spacer layer can be of an insulating material and can provide protection against shock.

The strip may further include a solid state gyroscope or accelerometer; a radio-based motion detector; a passive infrared motion detector; and/or a microphone based compressor monitor.

According to a second broad aspect, the invention provides a closure assembly for a cabinet having a base and sides defining a cavity for receiving stock, the closure assembly for installing above said cavity, the closure assembly having two opposed surfaces and comprising a camera system according to the first aspect incorporated on one of said surfaces. The closure assembly is preferably adapted for mounting on a cabinet as a sliding closure assembly.

According to a third broad aspect, the invention provides cabinet having a base and sides defining a cavity for receiving stock, and at least one closure assembly above said cavity, the closure assembly having an inward facing surface and an outward facing surface, said inward facing surface incorporating a camera system according to the first aspect. Preferably, the closure assembly is mounted on said cabinet as a sliding closure assembly.

The closure assembly of the cabinet may be detachable from the cabinet for cleaning and/or restocking and the cabinet may comprise an induction transmitter positioned so as not to interfere with detachment and replacement of the closure assembly. For example, the induction transmitter may be mounted on the exterior of the cabinet and at a distance from the closure assembly which permits induction but does not interfere with detachment and replacement of the closure assembly. Alternatively, the induction transmitter may be mounted on the interior of the cabinet and at a distance from the closure assembly which permits induction. Preferably, there is an induction transmitter positioned to be associated with each strip when the closure assembly is in a closed position.

The cabinet may further comprise a temperature sensor. The temperature sensor may be positioned inside the cabinet in a location to monitor the effective product core temperature, and data may be transmitted from the temperature sensor to the strip via a wireless technology. Optionally, the temperature sensor may be a liquid crystal temperature sticker in view of a camera, and temperature data may be obtained from the images taken by the camera.

The strip may be fixed to a glazing unit of the closure assembly. The cabinet may comprise more than one closure assembly.

In a particular embodiment, the front and rear of the cabinet are longer than the sides, and the closure assembly is curved and is mounted to slide laterally towards and away from the cabinet sides, and the strip fixed to the glazing unit comprises three sections: two end sections to be fixed under each of the opposed curved edges of the glazing unit of the closure assembly, each end section comprising sufficient number of cameras (typically 2 to 4 per edge) to allow monitoring of all product in the cabinet as the closure assembly is slid from open to closed and closed to open; and a middle section to be fixed to an edge of the glazing unit of the closure assembly which is parallel to the sliding direction of the closure assembly. The cabinet may include a second closure assembly, the strip being fixed to the closure assembly which is innermost with respect to the cavity of the cabinet. An induction transmitter may be mounted above the middle section, at a distance from the closure assembly which does not interfere with detachment and replacement of the closure assembly

For aesthetic reasons, decal strips may also be fixed to the corresponding edges of the other closure assembly(s) of the cabinet.

In another particular embodiment, the front and rear of the cabinet are longer than the sides, and the closure assembly is curved and is mounted to slide laterally towards and away from the cabinet sides, the camera system comprising a strip incorporated on the closure assembly comprising sufficient number of cameras (typically 2 to 4 per edge) to allow monitoring of all product in the cabinet as the closure assembly is slid from open to closed and closed to open. An induction transmitter may be located in the side wall of the cabinet, and the strip positioned to align with the induction transmitter when the closure assembly is in a closed position.

The cabinet may include a second closure assembly, a second strip fixed to said second closure assembly, and a second induction transmitter located in the second side wall of the cabinet, the second strip positioned to align with the second induction transmitter when the second closure assembly is in a closed position.

Referring to the second or third aspect, the strip may be incorporated in the joinery of said closure assembly instead of being attached to the glazing unit of a closure assembly.

As used herein, the term “stock” refers to individual units of goods stored in a cabinet, including but not limited to ice creams.

As used herein, the term “closure assembly” refers to a closure/door/window which is or can be mounted to a cabinet, preferably in a sliding arrangement. Generally the closure assembly is comprised of a glazing unit, which can be glass, acrylic or another suitable transparent material, and a joinery frame which holds and supports the glazing unit. The closure assembly can advantageously include a handle for operating the closure assembly.

### DESCRIPTION OF THE DRAWINGS

In further describing the invention, reference is made to the accompanying drawings in which:—

FIG. 1 is a perspective view of a freezer cabinet according to an embodiment of the invention;

FIG. 2 is a perspective view of a camera system installed on the freezer cabinet of FIG. 1;

FIGS. 3A and 3B are perspective views of a camera system installed on a freezer cabinet according to embodiments of the invention;

FIG. 4 is a partial perspective view of the camera system of FIG. 3A;

FIG. 5 is a top view of a cabinet according to the invention;

FIG. 6 is an exploded diagram of a camera system according to the invention; and

FIG. 7 is a plan view of a camera system incorporated on a closure assembly according to the invention.

### DETAILED DESCRIPTION

### Example 1—Freezer Cabinet Installed with Three-Section Strip

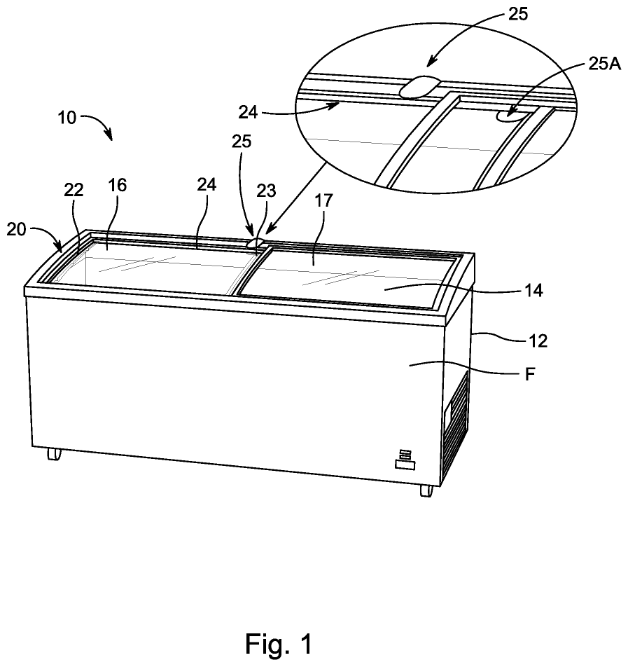

With reference to FIG. 1, a freezer cabinet 10 is shown. A camera system of the invention may be installed in freezer cabinet 10 during manufacture (termed original equipment manufacture or OEM), or alternatively, retrofitted into an existing freezer cabinet 10.

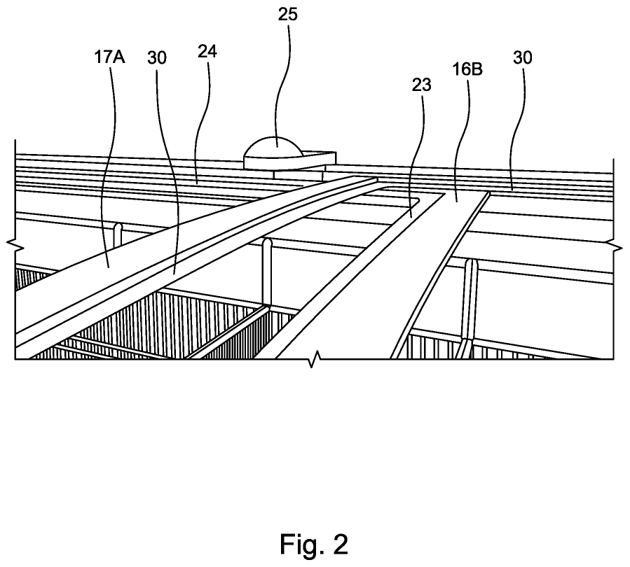

Freezer cabinet 10 comprises a housing 12, a freezer cavity 14 and sliding glass closure assemblies 16, 17. Freezer cabinet 10 may comprise baskets to hold different goods (not shown in FIG. 1; shown in FIG. 2). In the example shown in the drawing, closure assemblies 16 and 17 are curved, and are mounted to slide laterally towards and away from each other. Closure assembly 16 slides under closure assembly 17 and thus closure assembly 16 is the innermost closure assembly. In the embodiment shown, the housing 12 is configured to provide a “front” side F which has a lower overall height, from which customers and staff will access the freezer cabinet.

Freezer cabinet 10 comprises a camera system 20. The camera system comprises a strip fixed to closure assembly 16 comprising two end sections 22, 23 to be fixed by adhesion on the opposed curved edges of closure assembly 16, and each comprise three cameras directed inward to monitor goods in the freezer cabinet, and a circuit layer to receive and store data, including data recorded by the cameras.

A middle section 24 is fixed to the edge of closure assembly 16 which is at the “back” side of the freezer cabinet. Sections 22, 23, 24 are formed of a piece with one another to provide power and data transmission to all elements of the strip. Induction transmitter 25 is mounted above and provides power to section 24, via receiver 25a. In the embodiment shown, induction transmitter 25 is mounted to provide approximately 20-30 mm clearance to closure assembly 17, and in a position to be above closure assembly 16 when both closure assemblies are closed. This allows for removal of both closure assemblies for cleaning and maintenance as well as sliding of the closure assemblies in ordinary use. This provides the advantage that there is no need to alter the freezer cabinet or retrain staff. It will be appreciated that induction transmitter 25 may be positioned with reference of the “open” and “closed” positions of closure assemblies 16, thus allowing it to provide power to the camera system whether closure assemblies 16 is open or closed. However, induction transmitter 25 can be mounted anywhere, including along the long rear edge of the cabinet in the corners, and a side edge of the cabinet, where it can co-operate with the strip. An alternative arrangement where the induction transmitter is located on the side edge of the cabinet is given in example 2 below. In OEM embodiments, an induction transmitter may be installed inside the cabinet, where it is unobtrusive and will not need to accommodate removal of the glass closure assemblies. In other embodiments, instead of an induction transmitter, other means for supplying power could be used, including infrared LED(s) for transmitting energy to photovoltaic cells which can be coupled to the circuit layer.

The power supply to induction transmitter 25 may be integrated with that to the freezer cabinet. Alternatively, a separate power supply can be provided to induction transmitter 25.

In alternative embodiments, instead of fixing strip 22, 23, 24 on the glass of closure assembly 16, the strip can be incorporated into the joinery of the closure assembly.

It is envisaged that the power consumption of the camera system would be low, for example approx. 0.25 W. If illumination LEDs are present, power consumption may for example average approx. 0.5 W. In some embodiments, illumination LEDs can be incorporated into sections 22, 23, for refrigerator/freezer cabinets that are located in very dark locations or under stainless steel benches. Illumination LEDs can be programmed to illuminate when the closure assembly is closed, and for a limited number of seconds as the glass closure assembly is slid by the customer, and to turn off if the closure assembly is left open.

Referring to FIG. 2, edges 16B and 17A of closure assembly 16 and 17 respectively are shown overlapping, as closure assembly 16 is in an open position. In the embodiment shown, strip 22, 23, 24 is 20 mm wide and thus only minimally obscures the transparent panel of closure assembly 16. For aesthetic reasons, a matching decal strip can be applied to the corresponding edges of closure assembly 17. In FIG. 2 decal strips 30 are shown applied to the edges of closure assembly 17.

### Example 2—Freezer Cabinet Installed with Two Strips

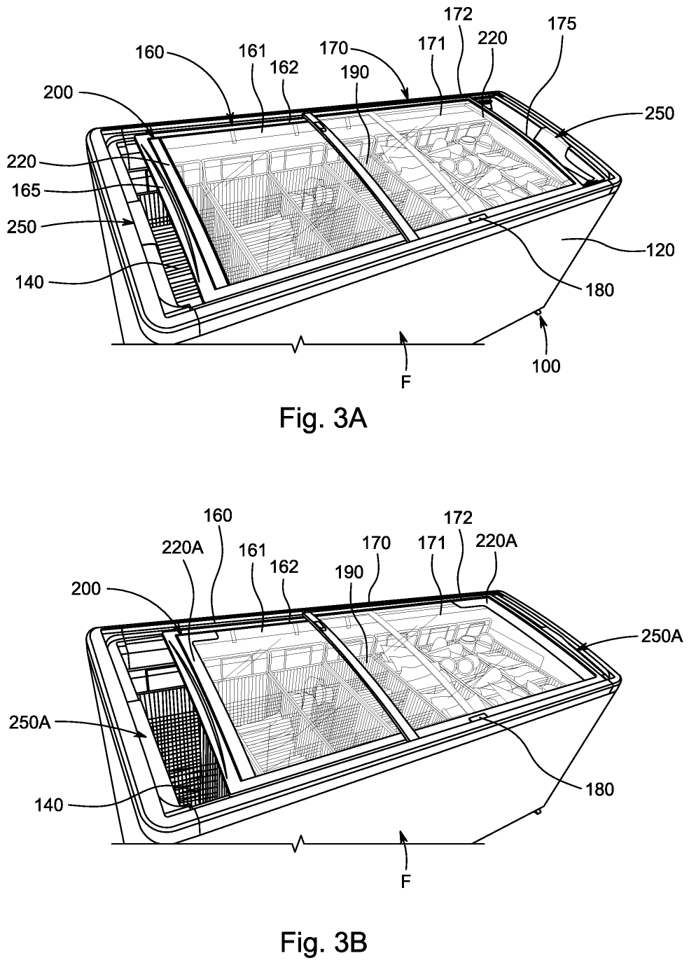

FIGS. 3A and 3B show a freezer cabinet 100 comprising a housing 120, a freezer cavity 140 and sliding glass closure assemblies 160, 170 each having a handle 165, 175 respectively on its upper side. Closure assembly 160 has a glazing unit (glass panel) 161 supported by joinery frame 162. Similarly, closure assembly 170 has a glazing unit 171 supported by joinery frame 172. Freezer cabinet 100 may comprise baskets to hold different goods. In this example shown in the drawing, closure assemblies 160 and 170 are curved and are mounted to slide laterally towards and away from each other; and the housing 120 is configured to provide a “front” side F which has a lower overall height, from which customers and staff will access the freezer cabinet. In ordinary use of the cabinet, guide 180 retains closure assemblies 160 and 170.

Freezer cabinet 100 comprises a number of freezer baskets 190, each basket having a number of compartments for holding various stock items.

Freezer cabinet 100 comprises a camera system 200. The camera system comprises two strips 220 fixed by adhesion to each of closure assemblies 160, 170 respectively. Depending on the length of the cabinet, one, two or more strips may be suitable, an induction transmitter being associated with each strip. Each strip comprises three cameras directed inward to monitor goods in the freezer cabinet, and a circuit layer to receive and store data, including data recorded by the cameras. In FIG. 3A the orthogonal shape of strips 220 is seen through the glass closure assembly. FIG. 3B shows a variation where the strips 220A have an “L-shape”, providing an opportunity for decoration or presentation of a logo which can be seen through the glass closure assembly.

As for the first example, a camera system of the invention may be installed in freezer cabinet 100 during manufacture (termed original equipment manufacture or OEM). One option for doing so is to manufacture the strip as part of the joinery frame of the closure assembly.

Alternatively, camera system 200 can be retrofitted into an existing freezer cabinet 100.

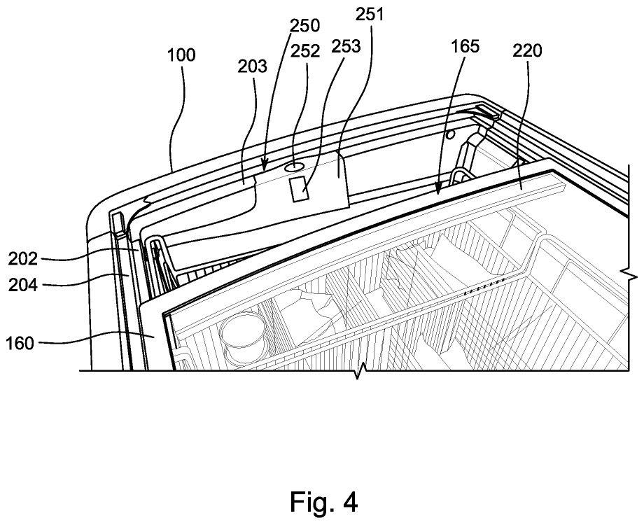

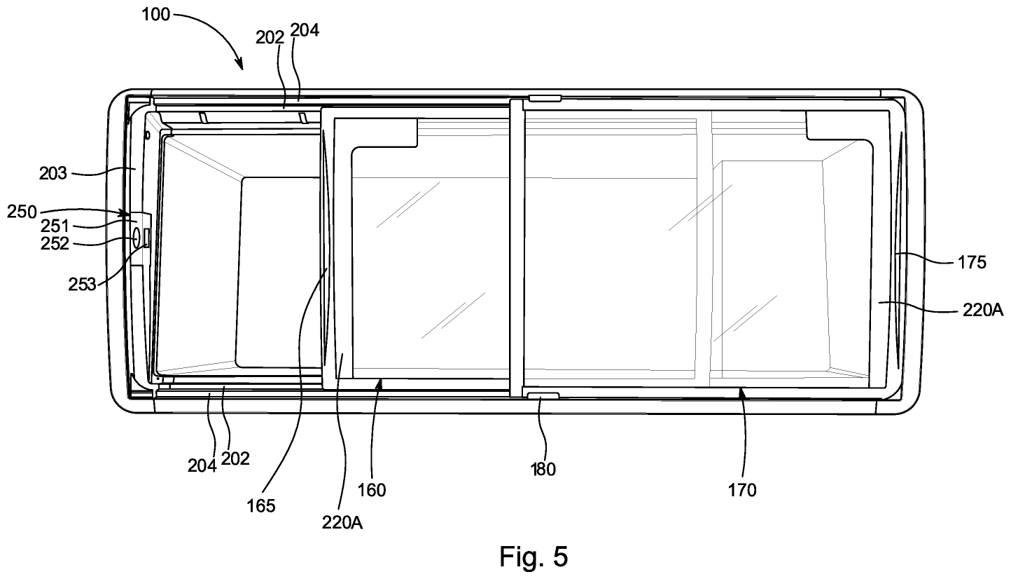

Referring to both FIGS. 3A and 3B, an induction transmitter 250/250A located in the side wall of the cabinet 100 provides power to a receiver (not shown in FIGS. 3-7) in each strip 220/220A. In the example of FIG. 3A, induction transmitters 250 are shown. Induction transmitters 250 have a slightly different shape to induction transmitters 250A in FIG. 3B; the differences are discussed further below. In the examples shown, the top edges of the housing 120 of cabinet 100 comprise ledges 202, 204 (FIGS. 4 and 5) which receive the sliding inner closure assembly 160 and outer closure assembly 170 respectively. The end of closure assembly 160 having handle 165 is received in the end 203 of ledge 202 when closure assembly 160 is in a closed position. Induction transmitter 250/250A is conveniently provided as a flexible decal 251 applied to end 203 of ledge 202 and the internal wall of the freezer cavity (FIG. 4), comprising a wireless transmitter coil 252 located on the horizontal face of ledge 203, and electronics 253 below coil 252 on the vertical face of decal 251.

As for the first example, this second example also allows for removal of both closure assemblies for cleaning and maintenance as well as sliding of the closure assemblies in ordinary use. In OEM, an induction transmitter may be installed inside the cabinet, where it is unobtrusive and will not need to accommodate removal of the glass closure assemblies. In other embodiments, instead of an induction transmitter, other means for supplying power could be used, including infrared LED(s) for transmitting energy to photovoltaic cells which can be coupled to the circuit layer.

FIG. 5 shows a top view of a typical freezer cabinet suitable for the invention, and the arrangement of ledges 202, 204 which bear the closure assemblies 160, 170. Inner closure assembly 160 is open and thus induction transmitter 250/decal 251 is visible. Outer closure assembly 170 is closed and thus the induction transmitter 250 associated with the strip on closure assembly 170 is obscured.

The power supply to induction transmitter 250/250A may be integrated with that to the freezer cabinet. For example, if the freezer cabinet 100 has an internal LED (e.g. an LED strip-light in the cavity of the cabinet, running across the entire front length of the cabinet, to illuminate the stock), the power supply to induction transmitters 250/250A may be coupled with the power supply to the internal LED, which power supply can be increased in power. This is illustrated in the Figures. In FIGS. 3A, 4 and 5, an induction transmitter 250 is shown applied to the centre of ledge 203 and extends down onto the internal side wall of the cabinet 100, and along the internal side wall to the front F of the cabinet. In the example of FIG. 3B, induction transmitter 250A is shown located on ledge 203 towards the front F of the cabinet, extending down onto the internal side wall. Each of these arrangements allows the coupling of the induction transmitters into the internal LED power supply. It will be apparent that while only one induction transmitter is visible in FIG. 5, each of these embodiments can have two induction transmitters, below closure assemblies 160 and 170 respectively (as shown in FIGS. 3A and 3B, where each closure assembly is partially ajar). Alternative to coupling the induction transmitter(s) with the power supply to an internal LED, a separate power supply can be provided to the induction transmitter(s).

In alternative embodiments, instead of fixing strip 220 on the glass of closure assembly 160, the strip can be incorporated in the joinery of the closure assembly.

### Strip

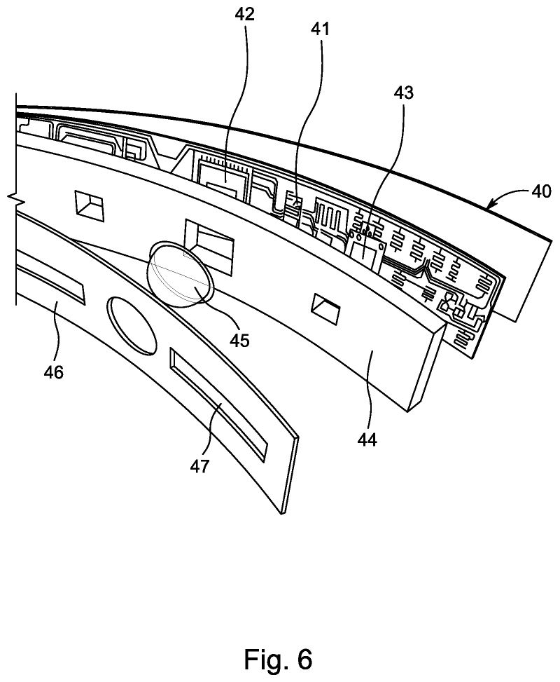

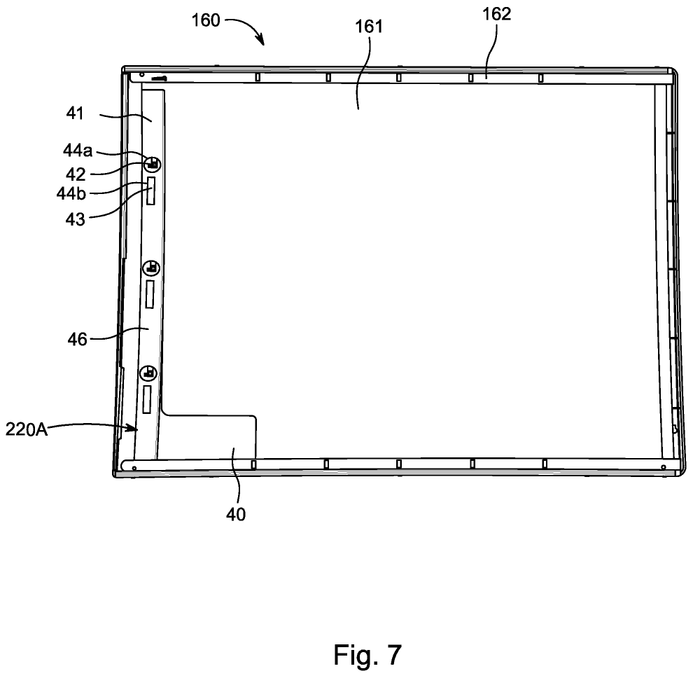

FIG. 6 shows the general construction of a strip according to an embodiment of the invention. In the embodiment shown, the strip comprises an adhesive layer 40, advantageously comprising a polycarbonate and polyester film. It will be appreciated that in other embodiments, the strip can be fixed to the inward facing surface of the cabinet by other means, for example screws or glue, or can be incorporated in the joinery of the closure assembly. A circuit layer 41 adjoins layer 40. Circuit layer 41 can be prepared using standard techniques and materials for making circuit boards. As will be seen in FIG. 7, the shape of adhesive layer 40 need not exactly match the shape of circuit layer 40.

The strip is designed to be located on the closure assembly of the cabinet. For a refrigerator/freezer cabinet, this is an ideal location as the closure assembly is the least insulated part of the refrigerator/freezer. Other locations are relatively colder than the closure assembly and placing a camera in the colder zones of the refrigerator/freezer can result in less efficient operation, fogging up and/or malfunction.

### Cameras and LEDs

One or more cameras 42 is provided to with layer 41. Optionally, the camera(s) may be provided with a small heating element to prevent misting of the lens or dome 45. Optionally, layer 41 can comprise one or more illumination LEDs 43.

The number of cameras 42 provided to the strip will depend on the size of the cabinet. Generally, in use, the strip will be located on a sliding closure assembly of the cabinet and oriented orthogonal to the direction of sliding. This means when the closure assembly is operated, each camera will be slid across a different section of the cabinet space. In the examples shown, three cameras are provided to each strip. Some overlap of the fields of view of the respective cameras is expected and can provide further advantages in introducing redundancy to the system.

### Spacer Layer

A spacer layer 44 can be formed from a plastics material such as a polycarbonate; and for example can be built up from multiple layers of self-adhesive polycarbonate or can be formed from a foamed material. Spacer layer 44 can be provided with cut-outs to accommodate the camera(s) and the illumination LED(s) if present, and may provide protection against shock. A dome 45 provides further protection to the camera and can be formed from e.g. acrylic.

### Cover Layer

Cover layer 46 can be formed from a plastics material and can include frosted windows 47 to protect the illumination LEDs and also act to diffuse light emitted by the illumination LEDs. In general, the layers can be attached to one another using adhesive. A typical overall thickness of the strip may be 5-15 mm, for example 8-12 mm.

FIG. 7 shows the inner surface (underside) of a closure assembly 160 for a freezer cabinet, with an L-shaped strip 220A such as that shown in FIGS. 3B and 5. Adhesive layer 40 has an L-shape and is adhered to glazing unit 161 of closure assembly 160. Circuit layer 41 is attached to adhesive layer 40 and is orthogonal in shape. Circuit layer 41 and adhesive layer 40 can be supplied as a single piece, or can be supplied as separate parts, with the adhesive layer 40 being installed first, and the circuit layer 41 then being adhered to the adhesive layer. Three cut-outs 44a in spacer layer 44 each accommodate a camera 42. Three further cut-outs 44b each accommodate an illumination LED 43.

An alternative to attaching the strip using adhesion is to incorporate it into joinery frame 162 during manufacture of the closure assembly.

### Data Transmission

Microprocessor(s) in circuit layer 41 can process images captured by the cameras, which can be stored in circuit layer 41 and then sent to a cloud server via a cellular transmitter (e.g. a LTE/4G cellular modem) for transmitting data collected to a cellular network. As discussed above, temperature monitoring is important for food safety. Optionally, a temperature sensor can also be provided in circuit layer 41. Additionally, or alternatively, a separate battery-powered temperature sensor with a Bluetooth transmitter can be fixed to the inside of the cabinet in the correct location to get a useful temperature reading (i.e. where it can monitor the effective product core temperature), and Bluetooth receiver can be provided in circuit layer 41. Communications relating to the temperature, stock levels, planogram compliance, openings of the closure assembly, motion detection etc can usefully be sent to a server via a cellular network. The server can then contact a technician and other parties interested in the cabinet or its contents as appropriate; via e.g. a customised APP, a browser interface, email or other messaging system or an API (application specific interface) into an Enterprise resource planning (ERP) system. For example, if the freezer cabinet temperature rises, data sent to the server can produce an alert, allowing either a manual response or automatic deployment of a technician, forestalling loss of goods.

A further optional component of the camera system is a solid state gyroscope or accelerometer. This component would monitor the opening or movement of one or more of the closure assemblies. When time-stamped and matched with ice cream consumption, this data will provide information on customer behaviour.

A further optional component of the camera system is a radio-based motion detector or a passive infrared motion detector. This component would detect each person walking past the cabinet and record the time of day, thus providing a traffic count which can be sent to the server.

A further optional component of the camera system is a microphone filtered to only pick up machine vibrations, e.g. a microphone based compressor monitor. This component would detect the operation of the refrigeration compressor or other devices in the cabinet allowing early detection of a possible fault condition onset.

### Methods of Monitoring Stock Levels

The camera(s) can be used to monitor the stock levels in the cabinet with reference to a planogram. This allows monitoring of planogram compliance at each delivery when the cabinet is restocked. It can also identify foreign objects in the cabinet as well as stock items returned to the wrong place by customers or staff. In addition, real-time monitoring can provide information on when popular varieties of goods are exhausted, allowing for demand-driven deliveries. Delivery cycles can be automatically adjusted for high-selling cabinets.

Monitoring the stock using downward-pointing camera(s) within the cabinet itself has advantages in that the view of the stock cannot be obscured by items external to the cabinet, and the cameras cannot capture images of staff or customers.

Monitoring of the stock can be achieved by using any number of various image recognition and/or optical analysis techniques. Some optical analysis/image recognition techniques are facilitated by the positioning of the strip(s) on the closure assemblies of the cabinet. It is particularly useful to position the strip(s) on slidably mounted closure assemblies. As the cameras move across the internal space of the cabinet, the camera system can be programmed to capture image(s) when the closure assembly on which it is installed is opened and/or closed; additionally, or alternatively, the camera system can be programmed to capture an image when the cabinet is restocked. Image recognition techniques can be used to compare the resulting data against the planogram for the cabinet.

In an embodiment, image recognition techniques can be used to gauge the distance of a product from the camera with reference to its relative size. Optionally, each item of stock can then by identified with reference to its SKU (stock keeping unit) particulars; the locations of each item of stock with reference to a zone (e.g. a basket) in the cabinet can then be reported to a database. Provided the dimensions of the zone/basket are known, this allows calculation of the number of items in a cabinet or a zone or basket of a cabinet, and accurate monitoring of the items, where alternative techniques such as measuring the weight of the products is impractical.

Optical analysis techniques include the use of an illumination LED to send light to the object, and measuring of the light reflected back to the optical sensor. Noise is accounted for by a control test where the illumination LED is not used. The distance between the camera and the object is determined based on relative luminance/brightness of the images.

Another optical analysis technique particularly useful in the invention in which the cameras move across the cabinet at a constant distance with respect to the base, is the relative speeds at which the stock objects travel across the camera's field of view (parallax).

Thus it will be seen a range of image recognition and optical analysis techniques can be applied to the camera system of the invention to monitor and report distance between the strip and the stock, allowing calculation of stock levels and planogram compliance.

Preferably, stock levels are reported to the database at least every day.

The invention allows customised planograms to be deployed in each retail outlet based on marketing needs or geographic/demographic characteristics.

The invention can be supplemented with a delivery app which can display the unique planogram for each freezer, even at times when internet access is not available due to e.g. congestion.

The invention may be retrofitted to most display cabinets and that shown in the drawings is for illustrative purposes only. While the invention is ideally suited to refrigerated or freezer cabinets, the cabinet can be refrigerated, controlled ambient or heated.

The above description is by way of example only and modifications are possible without departing from the scope of the invention.

The terms comprise, comprises, comprising, or comprised, if and when used herein, should be interpreted non-exclusively, that is, as conveying “consisting of or including”.

It is to be understood that, if any prior art publication is referred to herein, such reference does not constitute an admission that the publication forms a part of the common general knowledge in the art, in New Zealand or any other country.

1-32. (canceled)

33. A camera system for a cabinet having a cavity for receiving stock and a sliding closure at the top of the cavity, wherein the camera system comprises:
a strip configured to be positioned on the closure with a long axis of the strip transverse to a direction of sliding of the sliding closure; and
a power supply configured to provide electrical power to the strip;
wherein the strip comprises:
electrical circuitry including a power input device and a data output device; and
one or more cameras configured to point downwards when the strip is positioned on the closure, the one or more cameras operatively connected to the electrical circuitry and configured to monitor stock beneath the strip;
wherein the camera system is configured to monitor all of the stock beneath 15the strip as the closure is slid from open to closed or closed to open.

34. The camera system of claim 33 further comprising a second strip configured to be positioned:
on an end of the closure opposite the strip of claim 33 with a long axis of the second strip transverse to the direction of sliding of the closure; or
on a second closure with the long axis of the second strip transverse to the direction of sliding of the second closure;

35. The camera system of claim 34 wherein the camera system is configured to monitor all stock in the cabinet as the closure(s) is/are slid from open to closed or closed to open.

36. The camera system of claim 33 wherein the strip comprises two end sections configured to be positioned at opposite ends of the sliding closure with a long axis of each end section transverse to the direction of sliding of the sliding closure.

37. The camera system of claim 36 wherein the camera system is configured to monitor all stock in the cabinet as the closure is slid from open to closed or closed to open.

38. The camera system of claim 33 wherein the strip comprises a plurality of cameras arranged along its long axis.

39. The camera system of claim 33 wherein the camera system is configured to capture images of the stock using the one or more cameras when the closure is slide from open to closed or closed to open.

40. The camera system of claim 33 wherein the camera system comprises a motion detector.

41. The camera system of claim 33 wherein the camera system comprises an accelerometer to monitor opening or movement of the closure.

42. The camera system of claim 33 wherein the camera system is configured to determine the distance between the one or more cameras and stock in the cabinet.

43. The camera system of claim 42 wherein the camera system is configured to determine the distance between the one or more cameras and the stock using image recondition and/or optical analysis techniques.

44. The camera system of claim 43 wherein the camera system is configured to determine the distance between the one or more cameras and the stock based on the size of a product, brightness of light reflected from a stock object, or parallax of a stock object.

45. The camera system of claim 42 wherein the camera system is configured to calculate an amount of stock in the cabinet using the determined distance.

46. The camera system of claim 33 wherein the power supply comprises an 5inductive power transmitter and the power input device comprises an inductive power receiver.

47. The camera system of claim 33 wherein the strip comprises one or more lights to illuminate the interior of the cavity.

48. The camera system of claim 33 further comprising a temperature sensor, wherein the temperature sensor is:
in the strip; or
configured to communicate temperature information to the strip.

49. A cabinet comprising the camera system of claim 33, wherein the strip is positioned on a closure of the cabinet with the long axis transverse to the sliding direction of the closure.

50. A cabinet comprising the camera system of claim 46, wherein the strip is positioned on a closure of the cabinet with the long axis transverse to the sliding direction of the closure and wherein:
the inductive power transmitter and inductive power receiver are configured to couple to each other when the closure is in a closed position.

51. A camera system for a cabinet having a cavity for receiving stock and one or more sliding closures at the top of the cavity, wherein the camera system comprises:
one or more strips configured to be positioned on the one or more closures with a long axis of each strip transverse to a direction of sliding of the respective sliding closure; and
one or more power supplies configured to provide electrical power to the one or more strips;
wherein each strip comprises:
electrical circuitry including a power input device and a data output device; and
one or more cameras configured to point downwards when the strip is positioned on the closure, the one or more cameras operatively connected to the electrical circuitry and configured to monitor stock beneath the strip;
wherein the camera system is configured to monitor all of the stock in the cabinet as the closure(s) is/are slid from open to closed or closed to open.

52. A camera system for a cabinet having a cavity for receiving stock and a sliding closure at the top of the cavity, wherein the camera system comprises:
a strip configured to be positioned on the closure with a long axis of the strip transverse to a direction of sliding of the sliding closure; and
a power supply configured to provide electrical power to the strip;
wherein the strip comprises:
electrical circuitry including a power input device and a data output device; and
one or more cameras configured to point downwards when the strip is positioned on the closure, the one or more cameras operatively connected to the electrical circuitry and configured to monitor stock beneath the strip;
wherein the camera system is configured to determine the distance between the one or more cameras and stock in the cabinet and calculate an amount of stock in the cabinet using the determined distance.
